(19) United States
(12) Patent Application Publication
(10) Pub. No.: US 2011/0004769 A1
(43) Pub. Date: Jan. 6, 2011

(54) PASSWORD INPUT SYSTEM USING AN ALPHANUMERIC MATRIX AND PASSWORD INPUT METHOD USING THE SAME

(76) Inventors: Yoo-Jae Won, Gyeonggi-do (KR); Hyun-Cheol Jeong, Seoul (KR); Hwan-Jin Lee, Gyeonggi-do (KR); Byoung-Jin Han, Gyeonggi-do (KR)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/824,714

(22) Filed: Jun. 28, 2010

(30) Foreign Application Priority Data
Jul. 3, 2009 (KR) 10-2009-0060610

(51) Int. Cl. G06F 21/00

(52) U.S. Cl. 713/183

(57) ABSTRACT

The present invention relates to a password input algorithm, more particularly to a password input system and method using an alphanumeric matrix. An aspect of the invention can provide a password input system and method that can defend against keylogging attacks and shoulder surfing attacks, by having the final password inputted by way of certain alphanumeric matrix letters which are separated by a particular distance from the letters forming the password in the alphanumeric matrix. Also, an aspect of the invention can provide a password input system and method that can further increase the probability of defending against keylogging attacks and shoulder surfing attacks, by having the final password inputted by way of certain alphanumeric matrix letters which are separated by a particular distance from the letters forming the password in the alphanumeric matrix, but with the alphanumeric matrix rotated every time a letter is inputted.

### CROSS-REFERENCE TO RELATED APPLICATIONS

This application claims the benefit of Korean Patent Application No. 10-2009-0060610, filed with the Korean Intellectual Property Office on Jul. 3, 2010, the disclosure of which is incorporated herein by reference in its entirety.

### BACKGROUND

1. Technical Field

The present invention relates to a password input algorithm, more particularly to a password input system and method using an alphanumeric matrix.

2. Description of the Related Art

Generally, when using an Internet website or Internet banking, etc., an ID and password may be inputted for identification purposes. However, the existing method of inputting a password using a keyboard is highly vulnerable to keylogging attacks, in which the ID, password, etc., are discovered by recording the key information inputted by the user, and shoulder surfing attacks, in which the ID, password, etc., are discovered by looking over the user's shoulder (Shoulder surfing refers to any attack that may occur in a space that is beyond one's control and includes not only simple overlooking but also attacks using video images from CCTV cameras, etc.).

Of the 245 million types of malicious codes detected and blocked by Symantec Corp. each month last year, 90% targeted confidential information, and 76% of these were related to keylogging, for retrieving the keyboard input information of a user to steal authentication information for Internet bank accounts, etc. Numerous techniques have been developed to address this problem, i.e. that of complementing the keyboard-based password input method, and the most current of these techniques can be classified mainly into those using graphics and those requiring a person's computational abilities.

Certain current Internet banking sites have adopted the password input techniques using graphics, where the password (numbers) may be inputted by using a mouse. In most of these cases, the password is not a 6 to 8 digit combination of alphabet letters and numbers, but a 4 to 6 digit combination of numbers. The technique by which the password (numbers) is inputted using a mouse, as adopted by such Internet banking sites, may involve a number grid that is randomly generated on the screen whenever an input is made, rendering a keylogging attack ineffective. However, since this input involves inputting the numbers themselves, this technique can be vulnerable to shoulder surfing attacks. Due to this vulnerability of password input methods, the user is recommended not to use Internet banking services, or other websites, online games, etc., that require logging in, in a public environment, such as in an Internet café and on a public PC. In cases where it is unavoidably necessary to input a password using a keyboard in a public environment, and in cases subject to shoulder surfing, a user may suffer losses or may feel anxious about the possibility of information theft.

As such, there is a need to develop a password input method that is robust against both keylogging attacks and shoulder surfing attacks, so that users may feel at ease even when unavoidably using a password in a public environment.

### SUMMARY

An aspect of the invention is to provide a password input system using an alphanumeric matrix, and a password input method using the same, which can counter keylogging attacks and shoulder surfing attacks.

To achieve the objective above, an aspect of the invention provides a password input system using an alphanumeric matrix that includes: an alphanumeric matrix, which includes letters arranged in a matrix form, and which is configured to receive a password having n digits; and a password input confirmation module, which is configured to confirm a password inputted to the alphanumeric matrix. The password confirmation performed by the password input confirmation module may include confirming a letter forming the password (a first letter) from the input of a letter (a second letter) that is separated from the letter forming the password (the first letter) by a particular distance in the alphanumeric matrix. The password input confirmation module can confirm the letter forming the password (the first letter) from the input of the letter (the second letter) separated from the letter forming the password (the first letter) by a particular distance in the alphanumeric matrix, where the letter forming the password (the first letter) can be a cross-point in the alphanumeric matrix of a row of a first-digit letter and a column of a second-digit letter of a two-digit password letter sequence made by letters forming the password. The two-digit password letter sequence can include the password letter sequences of {[first digit, second digit], [second digit, third digit], . . . , [n-th digit, first digit]} of the password having n digits. The password input system can further include an alphanumeric matrix rotation/shuffle module that is configured to rotate a whole of the alphanumeric matrix or shuffle a row or column of the alphanumeric matrix.

Another aspect of the invention provides a password input system using an alphanumeric matrix that includes: an alphanumeric matrix, which includes letters arranged in a matrix form, and which is configured to receive a password having n digits; and a password input confirmation module, which is configured to confirm a password inputted to the alphanumeric matrix. The password confirmation performed by the password input confirmation module may include confirming a letter forming the password from the input of a cross-point in the alphanumeric matrix of a row of a first-digit letter and a column of a second-digit letter of a two-digit password letter sequence made by letters forming the password. The two-digit password letter sequence can be formed as {[first digit, second digit], [second digit, third digit], . . . , [n-th digit, first digit]} of the password having n digits. The password input system can further include an alphanumeric matrix rotation/shuffle module that is configured to rotate a whole of the alphanumeric matrix or shuffle a row or column of the alphanumeric matrix. The password input system can further include an input tool for inputting a password letter in the alphanumeric matrix, where the input tool can be any one selected from a group consisting of a keyboard, a keypad, a mouse, and a touchscreen.

Still another aspect of the invention provides a password input method using an alphanumeric matrix having letters arranged in a matrix form, where the password input method includes: recognizing a password letter in the alphanumeric matrix; and selecting and inputting an alphanumeric matrix letter located at a particular distance from the password letter in the alphanumeric matrix. The step of recognizing the password letter in the alphanumeric matrix can include: remembering two-digit password letter sequences from among an n number of letters forming the password; and recognizing the password letter located at a cross-point of a row of a first-digit letter and a column of a second-digit letter of each of the two-digit password letter sequences in the alphanumeric matrix. The two-digit password letter sequences can be formed as {[first digit, second digit], [second digit, third digit], . . . , [n-th digit, first digit]} of the password having n digits. The step of selecting and inputting an alphanumeric matrix letter located at a particular distance from the password letter in the alphanumeric matrix can further include: rotating a whole of the alphanumeric matrix or shuffling a row or column of the alphanumeric matrix, every time a selection of an alphanumeric matrix letter located at a particular distance from the password letter in the alphanumeric matrix is complete.

Yet another aspect of the invention provides a password input method using an alphanumeric matrix having letters arranged in a matrix form, where the password input method includes: remembering two-digit password letter sequences from among an n number of letters forming the password; and successively inputting the password letters each located at a cross-point of a row of a first-digit letter and a column of a second-digit letter of each of the two-digit password letter sequences in the alphanumeric matrix. The two-digit password letter sequences can be formed as {[first digit, second digit], [second digit, third digit], . . . , [n-th digit, first digit]} of the password having n digits. The step of successively inputting the password letters each located at a cross-point of a row of a first-digit letter and a column of a second-digit letter of each of the two-digit password letter sequences in the alphanumeric matrix can further include: rotating a whole of the alphanumeric matrix or shuffling a row or column of the alphanumeric matrix, every time an input of one of the n number of password letters in the alphanumeric matrix is completed.

An aspect of the invention can provide a password input system and method using an alphanumeric matrix that can defend against keylogging attacks and shoulder surfing attacks, by having the final password inputted by way of certain alphanumeric matrix letters which are separated by a particular distance from the letters forming the password in the alphanumeric matrix.

Another aspect of the invention can provide a password input system and method using an alphanumeric matrix that can further increase the probability of defending against keylogging attacks and shoulder surfing attacks, by having the final password inputted by way of certain alphanumeric matrix letters which are separated by a particular distance from the letters forming the password in the alphanumeric matrix, but with the alphanumeric matrix rotated every time a letter is inputted.

Another aspect of the invention can provide a password input system and method using an alphanumeric matrix that can defend against keylogging attacks and shoulder surfing attacks by having the user remember the letters forming the password in groups of two digits such that the first-digit letters are interrelated, and input their respective cross-points in the alphanumeric matrix as the final password.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic diagram illustrating a password input system using an alphanumeric matrix according to an aspect of the invention.

FIG. 2 is a flowchart illustrating a password input method using an alphanumeric matrix according to a first disclosed embodiment of the invention.

FIG. 3, FIG. 4, and FIG. 5 each show an alphanumeric matrix for illustrating a password input method using an alphanumeric matrix according to the first disclosed embodiment of the invention.

FIG. 6 is a flowchart illustrating a password input method using an alphanumeric matrix according to a second disclosed embodiment of the invention.

FIG. 7 illustrates a possible password for the second disclosed embodiment of the invention.

FIG. 8 and FIG. 9 each show an alphanumeric matrix for illustrating a password input method using an alphanumeric matrix according to the second disclosed embodiment of the invention.

### DETAILED DESCRIPTION

A detailed description of certain embodiments of the invention will be provided below with reference to the accompanying drawings. However, the invention is not limited to the embodiments disclosed below and can be implemented in various forms, as the embodiments are intended simply for complete disclosure of the invention and for complete understanding of the invention by those of ordinary skill in the art. In the accompanying drawings, like numerals refer to like components.

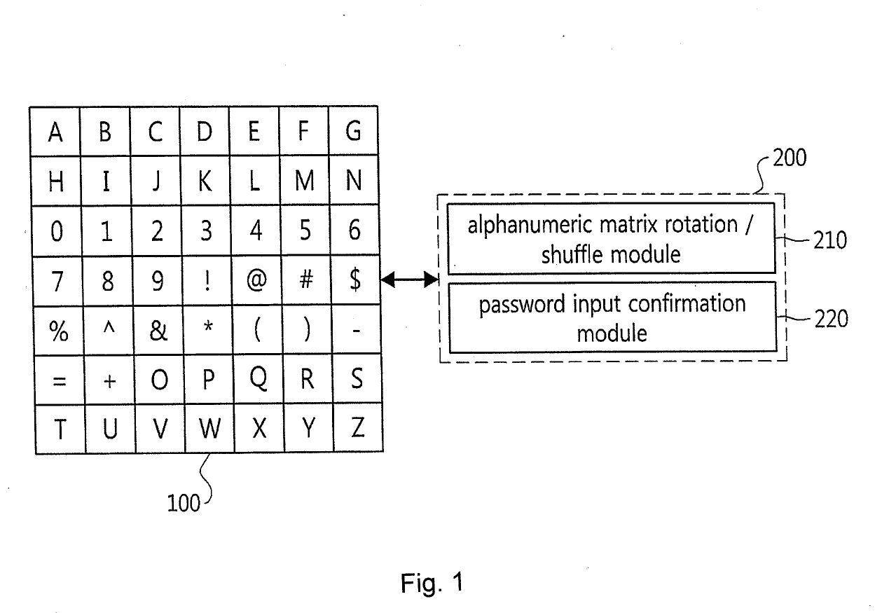

FIG. 1 is a schematic diagram illustrating a password input system using an alphanumeric matrix according to an aspect of the invention.

As illustrated in FIG. 1, a password input algorithm using an alphanumeric matrix according to an aspect of the invention may include an alphanumeric matrix 100, and an alphanumeric matrix operation module 200.

The alphanumeric matrix 100 is to enable a user to input a password. The alphanumeric matrix 100 may include letters arranged in a table having the form of a matrix. Here, the letters can include the 26 alphabet letters from ‘A’ to ‘Z’, the 10 numbers from ‘0 ’ to ‘9 ’, the 13 special characters from ‘ !’ to ‘=’, and so on. However, the letters of the alphanumeric matrix can include not only alphabet letters, i.e. of the English language, but also the letters of other common languages worldwide, such as the consonants and vowels of the Korean Hangul, Chinese characters, Japanese letters, etc. It may be desirable to have the letters of the alphanumeric matrix correspond to the English alphabet or to the local language of the country in which the invention is applied. For example, if an embodiment of the invention is applied in Korea, the letters of the alphanumeric matrix can include English letters, numbers, and special characters, or alternatively, Hangul consonants or vowels, numbers, and special characters. It may be desirable that the special characters include those listed above, i.e. the special characters available on a keyboard. Of course, other special characters other than those of this embodiment can also be used, including characters such as ‘[‘,’]’, ‘{’, ‘}’, ‘“’, ‘;’, etc., that are also available on a keyboard, and patterns, etc., that are not available on a keyboard. Also, the alphanumeric matrix can be a 7×7 alphanumeric matrix, as illustrated in FIG. 1, to support letter sequences. However, the invention is not thus limited, and the size of the alphanumeric matrix 100 can be adjusted to 6×6, 8×8, etc., according to the number of letters required. Of course, adjusting the size of the alphanumeric matrix 100 may involve adjusting the letters included in the alphanumeric matrix.

The alphanumeric matrix operation module 200 is for matrix operation, such as moving and rotating the alphanumeric matrix 100, as well as for confirming password input. The alphanumeric matrix operation module 200 may include an alphanumeric matrix rotation/shuffle module 210 and a password input confirmation module 220.

The alphanumeric matrix rotation/shuffle module 210 may rotate or shuffle the alphanumeric matrix 100 in a certain direction. Here, rotating the alphanumeric matrix 100 can be performed as a 90-degree, 180-degree, or 270-degree rotation in the left or right direction. Also, shuffling the alphanumeric matrix 100 can be performed by moving the rows and/or columns of the alphanumeric matrix 100 by one or more squares, i.e. shuffling. Such rotation and/or shuffling of the alphanumeric matrix can be more effective when performed every time a letter forming the password is successively inputted using the alphanumeric matrix. However, the invention is not thus limited, and the rotation and/or shuffling can be performed after one or more letters forming the password, such as two or three letters, for example, is inputted successively. Moreover, the rotation and/or shuffling of the alphanumeric matrix can also be performed after all of the letters forming the password is inputted, in preparation for the next instance of identification.

The password input confirmation module 220 may confirm whether or not the password inputted by the user is inputted correctly. If the password inputted by the user is not inputted correctly, the password input confirmation module 220 may send an error message to the user, and conversely, if the password inputted by the user is inputted correctly, the password input confirmation module 220 may send a password confirmation message to the system.

According to an embodiment of the invention, the input of a password can be performed as a user selects an alphanumeric matrix letter that is at a particular distance from a letter forming the password. Also, the user can input the password by remembering the letters of the password in groups of two digits, such that the last letter of the previous two-digit sequence is the first letter of the next two-digit sequence, and then selecting the cross-points of the two-digit sequences in the alphanumeric matrix 100. Here, a cross-point of a two-digit sequence refers to the point at which a row and a column of the two letters cross within the alphanumeric matrix 100. Of course, it is possible to define the cross-point as a crossing point of the row of the first letter and the column of the second letter, from among the two-digit letter sequence, and it is also possible to define the cross-point as a crossing point of the column of the first letter and the row of the second letter. It is important, here, that the method of finding the cross-point be kept consistent. Every time a letter forming the password is inputted using the two methods described above, the alphanumeric matrix 100 can be rotated and/or shuffled, to increase the likelihood of defending against keylogging attacks and shoulder surfing attacks. Of course, the password can also be inputted by finding the cross-points of the password and selecting the alphanumeric matrix letters that are at a particular distance from the cross-points, as described above. In addition, the alphanumeric matrix 100 can be rotated and/or shuffled every time a letter forming the password is inputted.

Thus, the password input confirmation module 220 may recognize such methods for password input, determine the password inputted by the user, and thereby identify the user. Then, upon receiving the password confirmation message, the system may complete the user identification process.

A password input system using an alphanumeric matrix 100 according to an embodiment of the invention may include an input tool (not shown) for inputting a password on the alphanumeric matrix 100. Here, if a keyboard is used for the input tool, a password can be directly inputted using the keys of the keyboard. If a keypad is used for the input tool, an indicator on the alphanumeric matrix letters, such as a highlight, etc., can be maneuvered to input a password. Of course, if a mouse or a touchscreen is used for inputting the password, the password can be inputted by clicking certain letters of the alphanumeric matrix 100 with the mouse or touching the letters with the touchscreen.

A description will now be provided, with reference to the accompanying drawings, on a password input method using an alphanumeric matrix according to a first disclosed embodiment of the invention that utilizes a password input system using an alphanumeric matrix described above. In the descriptions that follow, certain content that is redundant over the descriptions provided above regarding a password input algorithm using an alphanumeric matrix according to an aspect of the invention will be omitted or abridged.

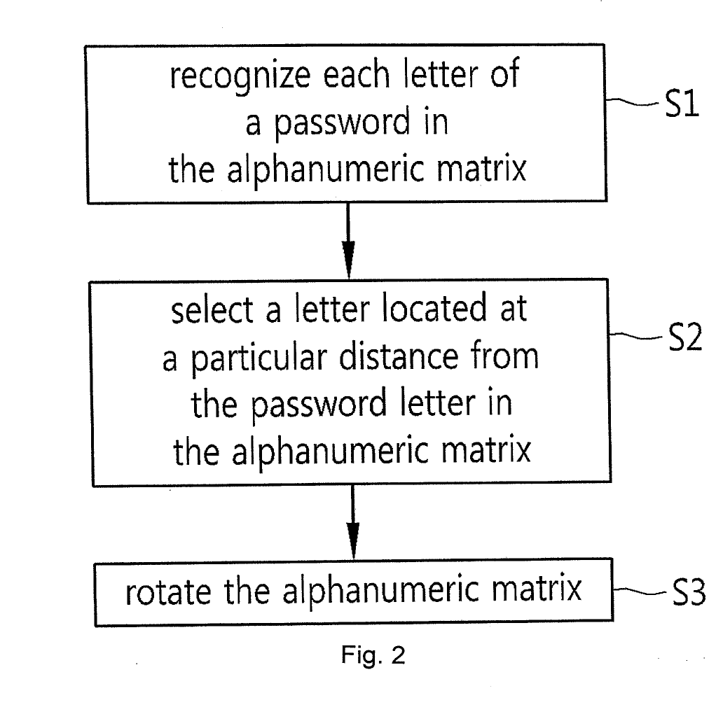

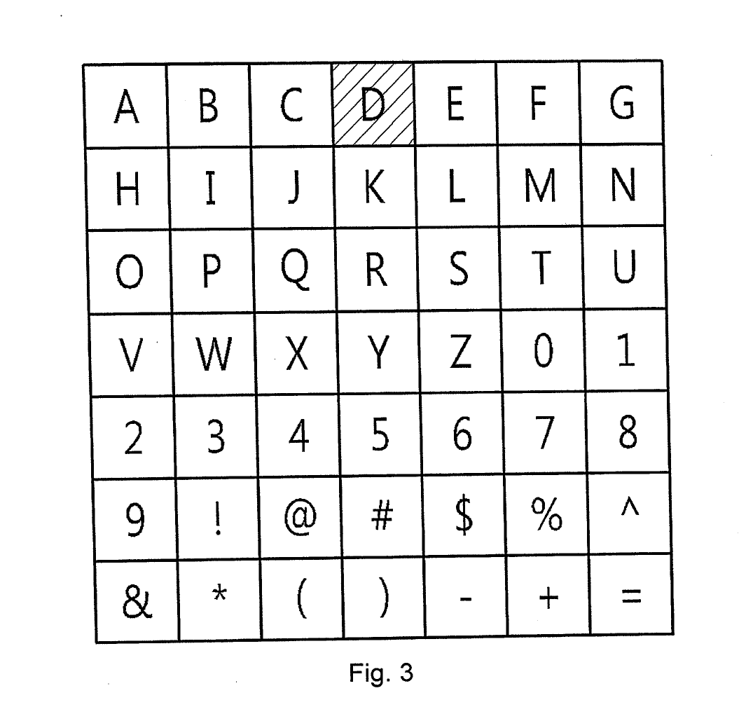

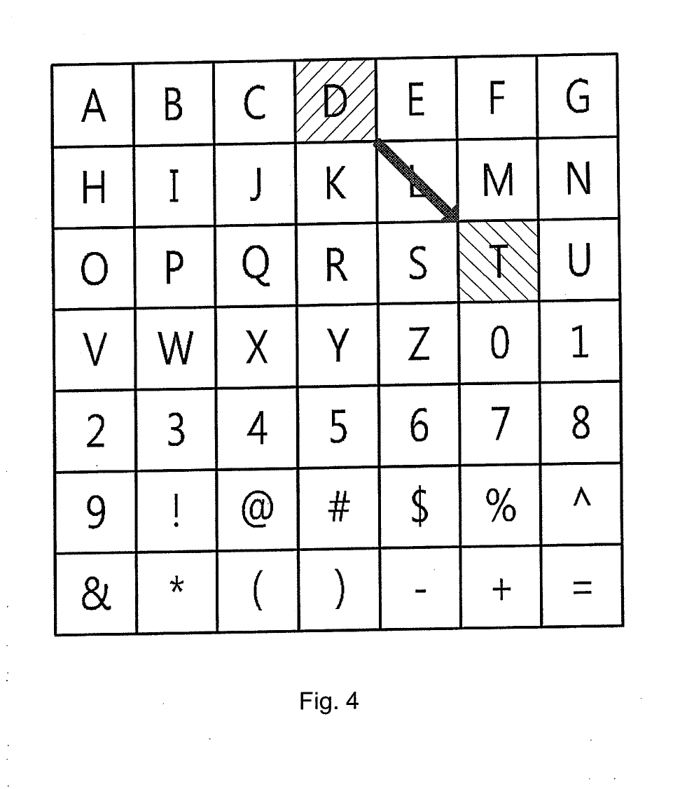

FIG. 2 is a flowchart illustrating a password input method using an alphanumeric matrix according to the first disclosed embodiment of the invention, and FIGS. 3 to 5 each show an alphanumeric matrix for illustrating a password input method using an alphanumeric matrix according to the first disclosed embodiment of the invention.

As illustrated in FIG. 2, a password input method using an alphanumeric matrix according to the first disclosed embodiment of the invention may include recognizing each letter of a password in the alphanumeric matrix (S₁), selecting a letter that is located at a particular distance from the password letter in the alphanumeric matrix (S₂), and rotating the alphanumeric matrix (S₃).

The step of recognizing each letter of a password in the alphanumeric matrix (S₁) may involve the user finding each of the letters forming the password in the alphanumeric matrix. For example, if the password is ‘DRAGON’, then the user may find ‘D’ in the alphanumeric matrix, as illustrated in FIG. 3.

The step of selecting a letter that is located at a particular distance from the password letter in the alphanumeric matrix (S₂) may involve inputting the password by successively selecting a letter located at a particular distance from each letter forming the password. For example, if the password is ‘DRAGON’, the user would have found ‘D’, the first letter forming the password, in the step of recognizing each letter of the password in the alphanumeric matrix (S₁). Accordingly, the user may select a letter in the alphanumeric matrix that is at a particular distance from ‘D’, the first letter forming the password. For example, the user can select ‘T’, which is a letter located two squares below and two squares to the right of the first letter of the password, ‘D’, as the first letter in an encrypted form, as illustrated in FIG. 3. Of course, the rest of the letters forming the password, ‘R’, ‘A’, ‘G’, ‘O ’, ‘N’ can also each be inputted in the same manner. Here, an input tool, such as a keyboard, keypad, mouse, touchscreen, etc., can be used for selecting the letters forming the password.

In order to increase the defense against keylogging attacks and shoulder surfing attacks, this embodiment can further include rotating the alphanumeric matrix every time a letter forming the password is inputted.

The step of rotating the alphanumeric matrix (S₃) may include rotating the alphanumeric matrix at every instance that the input of a letter forming the password is completed. This rotation of the alphanumeric matrix can be to rotate the alphanumeric matrix 90 degrees, 180 degrees, or 270 degrees to the left or the right. Of course, an embodiment of the invention can include not only rotating the alphanumeric matrix but also shuffling the alphanumeric matrix, by moving at least one or more rows and/or columns.

If the alphanumeric matrix is rotated 90 degrees to the right, for example, then the arrangement illustrated in FIG. 5 can be obtained, at which the user can again perform the steps described above of recognizing a letter of the password in the alphanumeric matrix (S₁) and selecting a letter that is located at a particular distance from the password letter in the alphanumeric matrix (S₂) to continue inputting the letters forming the password. That is, if the password is ‘DRAGON’, then the user can select ‘T’, which is located two squares below and two squares to the right of the second letter of the password, ‘R’, as the second letter in an encrypted form, as illustrated in FIG. 5. Of course, this step of rotating the alphanumeric matrix (S₃) can be omitted, in which case the embodiment can be used to input a password by performing the steps described above of recognizing a letter of the password in the alphanumeric matrix (S₁) and selecting a letter that is located at a particular distance from the password letter in the alphanumeric matrix (S₂).

As described above, this embodiment can provide a password input method using an alphanumeric matrix that can defend against keylogging attacks and shoulder surfing attacks, by having the final password inputted by way of certain alphanumeric matrix letters which are separated by a particular distance from the letters forming the password in the alphanumeric matrix. Also, the embodiment can provide a password input method using an alphanumeric matrix that can further increase the probability of defending against keylogging attacks and shoulder surfing attacks, by having the final password inputted by way of certain alphanumeric matrix letters which are separated by a particular distance from the letters forming the password in the alphanumeric matrix, but with the alphanumeric matrix rotated every time a letter is inputted.

A description will now be provided, with reference to the accompanying drawings, on a password input method using an alphanumeric matrix according to a second disclosed embodiment of the invention in which a cross-point for the password letters is found in the step of recognizing each letter of a password in the alphanumeric matrix. In the descriptions that follow, certain content that is redundant over the descriptions provided above regarding a password input method using an alphanumeric matrix according to the first disclosed embodiment of the invention will be omitted or abridged.

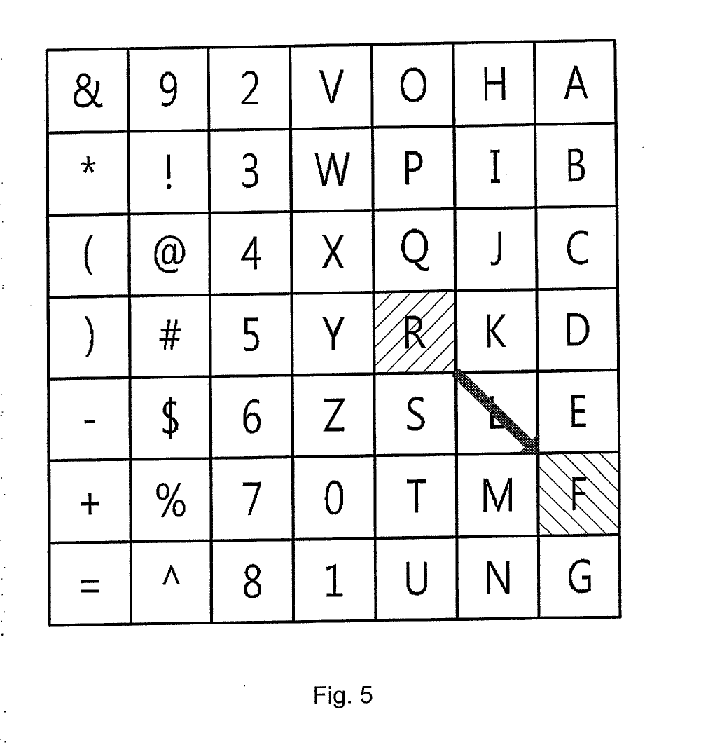

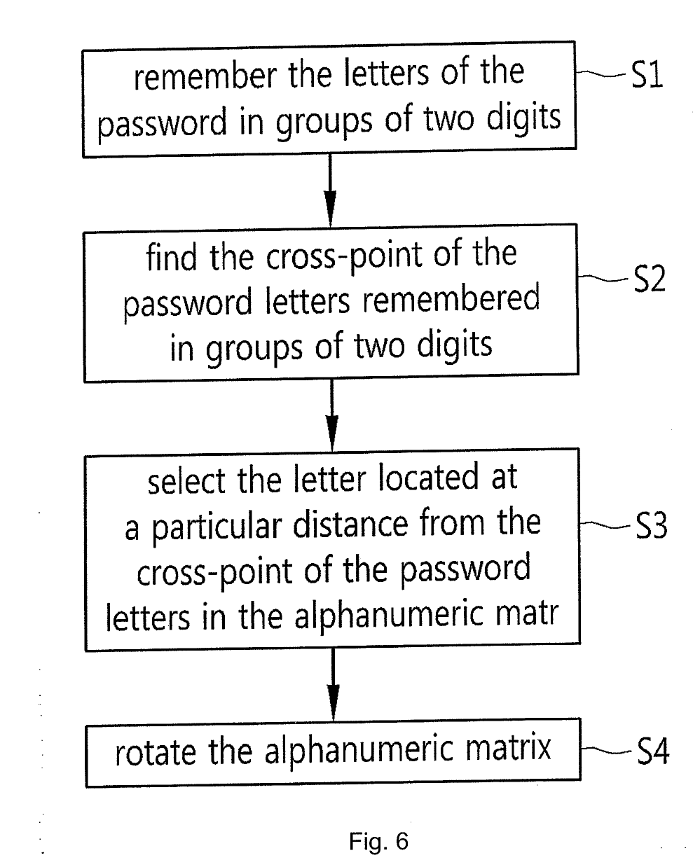

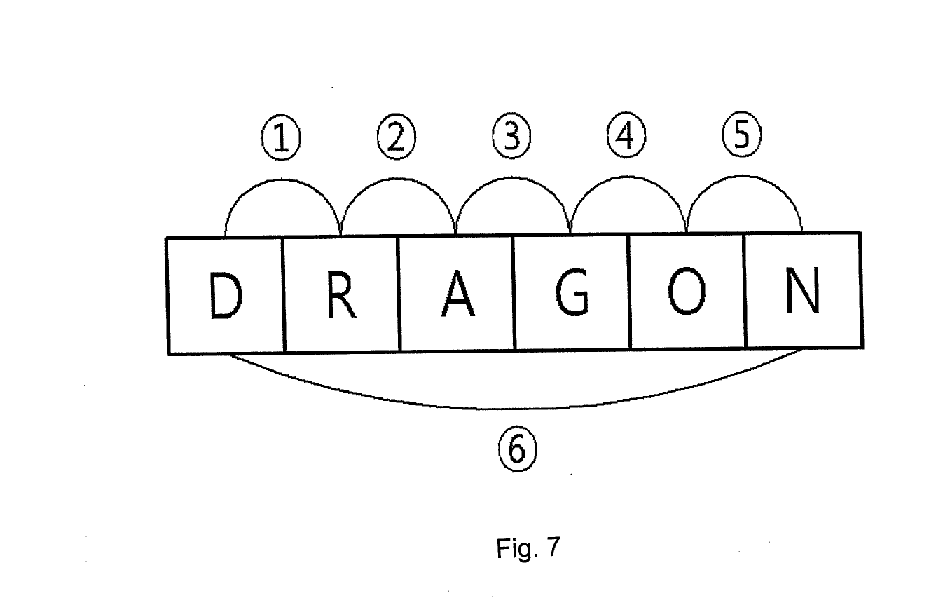

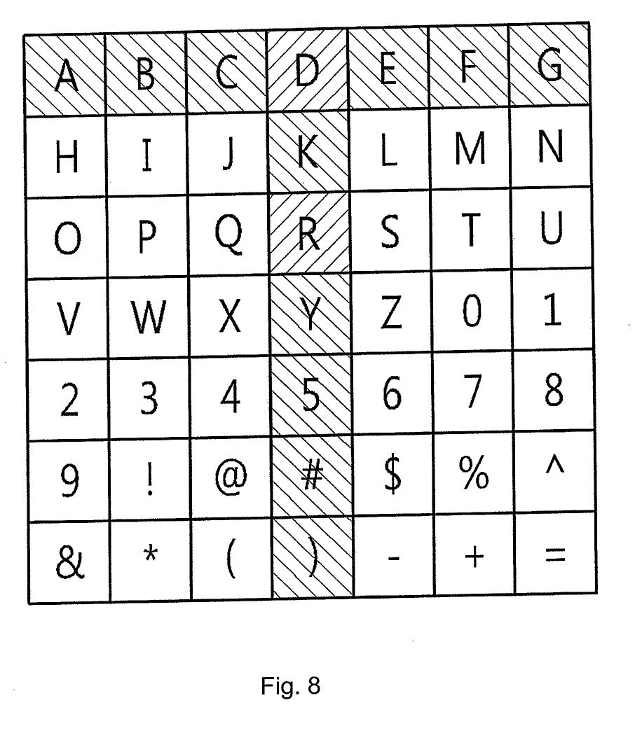

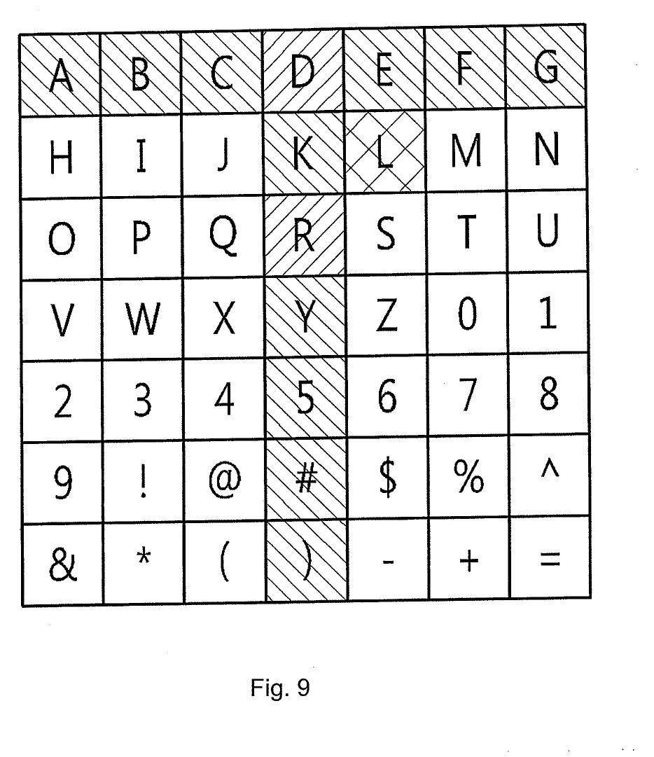

FIG. 6 is a flowchart illustrating a password input method using an alphanumeric matrix according to a second disclosed embodiment of the invention, and FIG. 7 illustrates a possible password for the second disclosed embodiment of the invention. Also, FIG. 8 and FIG. 9 each show an alphanumeric matrix for illustrating a password input method using an alphanumeric matrix according to the second disclosed embodiment of the invention.

As illustrated in FIG. 6, a password input method using an alphanumeric matrix according to the second disclosed embodiment of the invention may include remembering the letters of a password in groups of two digits (S₁), finding the cross-point of the password letters remembered in groups of two digits (S₂), selecting a letter that is located at a particular distance from the cross-points of the password letters in the alphanumeric matrix (S₃), and rotating the alphanumeric matrix (S₄).

The step of remembering the letters of the password in groups of two digits (S₁) may include the user remembering the password in groups of two digits, starting from the front. For example, if the password is ‘DRAGON’, as illustrated in FIG. 7, then the user may remember ‘DRAGON’ as ‘DR’(\textcircled{1}), ‘RA’(\textcircled{2}), ‘AG’(\textcircled{3}), ‘GO’(\textcircled{4}), ‘ON’(\textcircled{5}), ‘ND’(\textcircled{6}), i.e. in groups of two digits such that the front-digit letters are interrelated. Of course, the invention is not thus limited, and it is also possible to simply remember the password for every two digits. That is, if the password is ‘DRAGON’, then the user can remember ‘DRAGON’ as ‘DR’, ‘AG’, ‘ON’. Also, the password can be remembered in groups of two digits with a basis on the letter of a particular position. For example, using ‘D’ in ‘DRAGON’ as the basis, each letter of the password can be remembered by grouping ‘D’ with each of ‘R’, ‘A’, ‘G’, ‘O ’, ‘N’ as ‘DR’, ‘DA’, ‘DG’, ‘DO’, ‘DN’.

The step of finding the cross-points of the password letters remembered in groups of two digits (S₂) may include finding the cross-points for the password letters remembered in groups of two digits in the alphanumeric matrix. Here, using x, y to represent the first two-digit letter group of the password, the computation of f(x,y)=z may be determined by the rows and columns of letters x, y as positioned in the alphanumeric matrix. For example, if the password is ‘DRAGON’, the first password letter cross-point for ‘DR’ is ‘D’, which is positioned at the cross-point of ‘D’ and ‘R’ in the alphanumeric matrix, as illustrated in FIG. 8. That is, for finding f(x,y), the user may select a row and column according to the positions for each letter sequence in the alphanumeric matrix. There is always a cross-point for the row and column thus selected, and the cross-point is the result of the computation. In the above case for ‘D’ and ‘R’, f(D,R)=D*R=D. In like manner, for ‘RA’ in FIG. 8, the ‘O’ positioned at the cross-point of ‘R’ and ‘A’ in the alphanumeric matrix becomes the second password letter cross-point. Also, for ‘AG’, the ‘G’ positioned at the cross-point of ‘A’ and ‘G’ in the alphanumeric matrix becomes the third password letter cross-point, and for ‘GO’, the ‘A’ positioned at the cross-point of ‘G’ and ‘O’ in the alphanumeric matrix becomes the fourth password letter cross-point. Also, for ‘ON’, the ‘U’ positioned at the cross-point of ‘O’ and ‘N’ in the alphanumeric matrix becomes the fifth password letter cross-point, and for ‘ND’, the ‘K’ positioned at the cross-point of ‘N’ and ‘D’ in the alphanumeric matrix becomes the sixth password letter cross-point. Thus, the first to sixth password letter cross-points, namely, ‘D’, ‘O’, ‘G’, ‘A’, ‘U’, and ‘K’ become the password letter cross-points for the password ‘DRAGON’. With this setup, it is difficult to make out which two letters were originally used as input for the computation, even when the user selects a cross-point. That is, an attacker can only obtain information regarding the row and column in which the two letters are positioned.

The step of selecting a letter that is located at a particular distance from the cross-point of the password letters in the alphanumeric matrix (S₃) may involve selecting an alphanumeric matrix letter that is at a particular distance from each of the letters forming the password, i.e. the password letter cross-points, and thereby inputting the password, in a similar fashion to the first disclosed embodiment of the invention described above. For example, if a password letter cross-point is ‘D’, as illustrated in FIG. 9, then a letter located at a particular distance from ‘D’, for example, the letter ‘L’ located one square below and one square to the right, can be inputted as the final password. Of course, all of the password letter cross-points can be inputted in a similar manner by the method described above.

The step of rotating the alphanumeric matrix (S₄) may include rotating and/or shuffling the alphanumeric matrix after every instance completing the input of a letter forming the password, i.e. a password letter cross-point, in a similar fashion to the first disclosed embodiment of the invention described above.

Of course, at least one of the steps of selecting a letter that is located at a particular distance from the cross-point of the password letters in the alphanumeric matrix (S₃) and rotating the alphanumeric matrix (S₄) can be omitted, in which case the embodiment can be used to input a password by performing the steps described above of remembering the letters of a password in groups of two digits (S₁), finding the cross-point of the password letters remembered in groups of two digits (S₂), and selecting a letter that is located at a particular distance from the cross-point of the password letters in the alphanumeric matrix (S₃), or by performing the steps of remembering the letters of a password in groups of two digits (S₁), and finding the cross-point of the password letters remembered in groups of two digits (S₂), and then inputting the cross-point of the password letters.

As described above, this embodiment can provide a password input method using an alphanumeric matrix that can defend against keylogging attacks and shoulder surfing attacks by having the user remember the letters forming the password in groups of two digits such that the first-digit letters are interrelated, and input their respective cross-points in the alphanumeric matrix as the final password.

While the present invention has been described above with reference to particular drawings and embodiments, those skilled in the art will understand that numerous variations and modifications can be conceived without departing from the spirit of the present invention as disclosed by the scope of claims below.

What is claimed is:

1. A password input system using an alphanumeric matrix, the password input system comprising:
an alphanumeric matrix including letters arranged in a matrix form, the alphanumeric matrix configured to receive a password having n digits; and
a password input confirmation module configured to confirm a password inputted to the alphanumeric matrix,
wherein a password confirmation by the password input confirmation module comprises confirming a letter forming the password (a first letter) from an input of a letter (a second letter) separated from the letter forming the password (the first letter) by a particular distance in the alphanumeric matrix.

2. The password input system using an alphanumeric matrix according to claim 1, wherein the password input confirmation module confirms the letter forming the password (the first letter) from the input of the letter (the second letter) separated from the letter forming the password (the first letter) by a particular distance in the alphanumeric matrix, and wherein the letter forming the password (the first letter) is a cross-point in the alphanumeric matrix of a row of a first-digit letter and a column of a second-digit letter of a two-digit password letter sequence made by letters forming the password.

3. The password input system using an alphanumeric matrix according to claim 2, wherein the two-digit password letter sequence includes password letter sequences of {[first digit, second digit], [second digit, third digit], . . . , [n-th digit, first digit]} of the password having n digits.

4. The password input system using an alphanumeric matrix according to claim 1, further comprising:
an alphanumeric matrix rotation/shuffle module configured to rotate a whole of the alphanumeric matrix or shuffle a row or column of the alphanumeric matrix.

5. The password input system using an alphanumeric matrix according to claim 1, further comprising:
an input tool for inputting a password letter in the alphanumeric matrix,
wherein the input tool is any one selected from a group consisting of a keyboard, a keypad, a mouse, and a touchscreen.

6. A password input system using an alphanumeric matrix, the password input system comprising:
an alphanumeric matrix including letters arranged in a matrix form, the alphanumeric matrix configured to receive a password having n digits; and
a password input confirmation module configured to confirm a password inputted to the alphanumeric matrix,
wherein a password confirmation by the password input confirmation module comprises confirming a letter forming the password from an input of a cross-point in the alphanumeric matrix of a row of a first-digit letter and a column of a second-digit letter of a two-digit password letter sequence made by letters forming the password.

7. The password input system using an alphanumeric matrix according to claim 5, wherein the two-digit password letter sequences are formed as {[first digit, second digit], [second digit, third digit], . . . , [n-th digit, first digit]} of the password having n digits.

8. The password input system using an alphanumeric matrix according to claim 5, further comprising:
an alphanumeric matrix rotation/shuffle module configured to rotate a whole of the alphanumeric matrix or shuffle a row or column of the alphanumeric matrix.

9. A password input method using an alphanumeric matrix having letters arranged in a matrix form, the password input method comprising:
recognizing a password letter in the alphanumeric matrix; and
selecting and inputting an alphanumeric matrix letter located at a particular distance from the password letter in the alphanumeric matrix.

10. The password input method using an alphanumeric matrix according to claim 9, wherein the recognizing of the password letter in the alphanumeric matrix comprises:
remembering two-digit password letter sequences from among an n number of letters forming the password; and
recognizing the password letter located at a cross-point of a row of a first-digit letter and a column of a second-digit letter of each of the two-digit password letter sequences in the alphanumeric matrix.

11. The password input method using an alphanumeric matrix according to claim 10, wherein the two-digit password letter sequences are formed as {[first digit, second digit], [second digit, third digit], . . . , [n-th digit, first digit]} of the password having n digits.

12. The password input method using an alphanumeric matrix according to claim 11, wherein the selecting and inputting of an alphanumeric matrix letter located at a particular distance from the password letter in the alphanumeric matrix further comprises:
rotating a whole of the alphanumeric matrix or shuffling a row or column of the alphanumeric matrix, every time a selection of an alphanumeric matrix letter located at a particular distance from the password letter in the alphanumeric matrix is complete.

13. A password input method using an alphanumeric matrix having letters arranged in a matrix form, the password input method comprising:
remembering two-digit password letter sequences from among an n number of letters forming the password; and
successively inputting the password letters each located at a cross-point of a row of a first-digit letter and a column of a second-digit letter of each of the two-digit password letter sequences in the alphanumeric matrix.

14. The password input method using an alphanumeric matrix according to claim 13, wherein the two-digit password letter sequences are formed as {[first digit, second digit], [second digit, third digit], . . . , [n-th digit, first digit]} of the password having n digits.

15. The password input method using an alphanumeric matrix according to claim 14, wherein the successive inputting of the password letters each located at a cross-point of a row of a first-digit letter and a column of a second-digit letter of each of the two-digit password letter sequences in the alphanumeric matrix further comprises:
rotating a whole of the alphanumeric matrix or shuffling a row or column of the alphanumeric matrix, every time an input of one of the n number of password letters in the alphanumeric matrix is completed.
